(19) United States
(12) Patent Application Publication
(10) Pub. No.: US 2008/0086648 A1
(43) Pub. Date: Apr. 10, 2008

(54) METHOD FOR ADJUSTING A CHARGING TIME OF AN ELECTRONIC DEVICE COUPLED TO A COMPUTER SYSTEM

(76) Inventors: Tung-Sheng Lin, Taipei Hsien (TW); Wei-Chih Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/620,731

(22) Filed: Jan. 8, 2007

(30) Foreign Application Priority Data
Oct. 5, 2006 (TW) 095137089

(51) Int. Cl. G06F 1/00

(52) U.S. Cl. 713/300

(57) ABSTRACT

When a current for charging an electronic device is too small, when the electronic device has been charged for a long time, or when the electronic device still needs to be charged for a long time, a solution involves increasing the current used for charging the electronic device. This will avoid the problem of the electronic device not being completely charged within a limited time.

### BACKGROUND OF THE INVENTION

1. Field of the Invention

The invention relates to a method for adjusting a charging time, and more specifically, to a method for adjusting a charging time of an electronic device coupled to a computer system.

2. Description of the Prior Art

With the improvement of technology, electronic products have become much smaller and lighter. A portable notebook is a representative example.

For the purpose of portability, a notebook is usually equipped with a battery capable of supplying power to the system independently so that a user still can use the notebook even without being connected to AC power. However, just like other portable electronic products, the notebook also has a problem of charging its rechargeable battery. In general, when a rechargeable battery is coupled to 110V AC power, it can be charged completely within 4 to 8 hours. But there are exceptions. For example, when the notebook is working at full speed or is at a high loading state, the overall power consumption of the other components other than the rechargeable battery is too high, meaning that the current available for charging the rechargeable battery can not reach the maximum value. In such a manner, the charging time is extended. Moreover, the rechargeable battery may not be charged completely. It is inconvenient and time-wasting for the user.

### SUMMARY OF THE INVENTION

The invention discloses a method for adjusting a charging time of an electronic device coupled to a computer system comprising adjusting a charging current from the computer system to the electronic device according to a charging status of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to the present invention.

FIG. 2 is a flowchart of a method for adjusting a charging current flowing into the electronic device in FIG. 1 according to the magnitude of the charging current flowing into the electronic device.

FIG. 3 is a flowchart of a method for adjusting a charging current flowing into the electronic device in FIG. 1 according to the magnitude of the charging time that the electronic device still needs to be charged.

FIG. 4 is a flowchart of a method for adjusting a charging current flowing into the electronic device in FIG. 1 according to the magnitude of the charging time that the electronic device has been charged.

### DETAILED DESCRIPTION

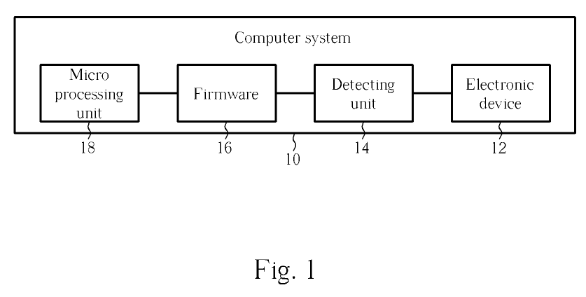

Please refer to FIG. 1. FIG. 1 is a functional block diagram of a computer system 10 according to the present invention. The computer system 10 comprises an electronic device 12, a detecting unit 14, a firmware 16, and a micro processing unit 18. The detecting unit 14 is coupled to the electronic device 12 and the firmware 16. The detecting unit 14 is used for detecting the charging status of the electronic device 12. The firmware 16 is used for adjusting the performance of the micro processing unit 18 according to the detecting result of the detecting unit 14. The computer system 10 can be a notebook. The electronic device 12 can be a rechargeable battery or a USB (Universal Serial Bus) device. The firmware 16 is formed inside a BIOS (Basic Input/Output system). Furthermore, The firmware 16 can be replaced with software to adjust the performance of the micro processing unit 18.

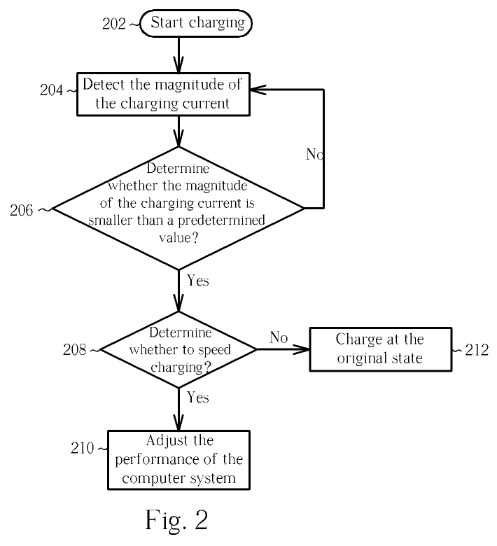

Please refer to FIG. 2. FIG. 2 is a flowchart of a method for adjusting the charging current flowing into the electronic device 12 according to the magnitude of the charging current flowing into the electronic device 12. The method comprises the following steps.

Step 202: Start charging the electronic device 12;

Step 204: The detecting unit 14 detects the charging current flowing into the electronic device 12;

6 Step 206: The detecting unit 14 determines whether the magnitude of the charging current flowing into the electronic device 12 is smaller than a predetermined value. If so, go to Step 208; if not, go back to Step 204;

7 Step 208: The user determines whether to speed charging. If so, go to Step 210; if not, go to Step 212;

Step 210: The firmware 16 adjusts the performance of the computer system 10;

Step 212: Charge the electronic device 12 at the original state.

There are more detailed descriptions for FIG. 2. First, the charged object mentioned in Step 202 is the electronic device 12. The electronic device 12 can be a rechargeable battery or a USB device. If the electronic device 12 is a rechargeable battery, starting charging the electronic device 12 means starting charging the rechargeable battery after the computer system 10 is coupled to AC power. And if the electronic device 12 is a USB device, the computer system 10 is not necessarily coupled to AC power. That is to say, the battery installed inside the computer system 10 can be utilized to charge the USB device. Next, when the electronic device 12 is charged, the detecting unit 14 starts to detect the charging current flowing into the electronic device 12. If the electronic device 12 is a battery, the detecting unit 14 can detect the magnitude of the charging current flowing into the electronic device 12 through being coupled to the electronic device 12. And if the electronic device 12 is a USB device, the detecting unit 14 can detect the current flowing into the other components other than the electronic device 12 inside the computer system 10 through being coupled to these components. Then the magnitude of the charging current flowing into the electronic device 12 can be calculated. Finally, the detecting unit 14 determines whether the magnitude of the charging current flowing into the electronic device 12 is smaller than a predetermined value. For example, if the predetermined value is 2 A(ampere), the magnitude of the charging current flowing into the electronic device 12 smaller than 2 A represents that the charging current flowing into the electronic device 12 is too small. That means the charging time of the electronic device 12 will be too long. Then, the computer system 10 will provide a user with an option to speed charging under this circumstance. When the user chooses to speed charging, the firmware 16 will start to adjust the performance of the computer system 10 for distributing more current to flow into the electronic device 12 as described in Step 210. And when the user chooses not to speed charging, the firmware 16 will not execute adjusting the performance of the computer system 10. That is to say, the electronic device 12 will be charged by the initial current when coupled to the computer system 10. Step 208 and step 210 can be omitted.

The methods for adjusting the performance of the computer system 10 mentioned in Step 208 are prior art methods. The objective of Step 208 is decreasing the power consumption of the other components other than the electronic device 12, such as making the computer system 10 enter into the power-saving mode or reducing the clock frequency and voltage of chipsets inside the computer system 10 (such as starting chipset throttling mode), in order to increase the charging current flowing into the electronic device 12. The former method for decreasing the power consumption of the computer system 10 involves decreasing the power consumption of hardware inside the computer system 10 (such as lowering the brightness of the display device or the rotation rate of the fan), or closing loaded software (such as closing resident software). The latter method for decreasing the power consumption of the computer system 10 involves reducing the clock frequency or voltage of the micro processing unit 18 inside the computer system 10. For example, the micro processing unit 18 can be a CPU (center processing unit). Reducing the clock frequency or voltage of the micro processing unit 18 inside the computer system 10 means making the CPU enter into P state (performance state). In general, the power consumption of the CPU is the largest of all components inside the computer system 10. Therefore, when the firmware 16 makes the CPU enter into P state, the overall power consumption of the other components other than the electronic device 12 inside the computer system 10 drops sharply. In such a manner, the charging current flowing into the electronic device 12 can increase substantially. That means the charging time of the electronic device 12 can be shortened.

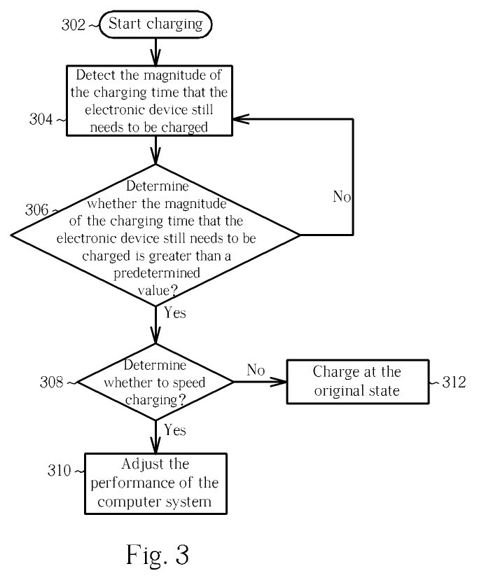

Please refer to FIG. 3. FIG. 3 is a flowchart of a method for adjusting the charging current flowing into the electronic device 12 according to the magnitude of the charging time that the electronic device 12 still needs to be charged. The method comprises the following steps.

Step 302: Start charging the electronic device 12;

Step 304: The detecting unit 14 detects the charging time that the electronic device 12 still needs to be charged;

Step 306: The detecting unit 14 determines whether the magnitude of the charging time that the electronic device 12 still needs to be charged is greater than a predetermined value. If so, go to Step 308. If not, go to Step 304;

Step 308: The user determines whether to speed charging. If so, go to Step 310. If not, go to Step 312;

Step 310: The firmware 16 adjusts the performance of the computer system 10;

Step 312: Charge the electronic device at the original state.

Steps mentioned in both FIG. 2 and FIG. 3 represent similar steps. Step 306 in FIG. 3 is a step for determining whether the charging time of the electronic device 12 is too long. For example, if the predetermined value is 8 hours, the charging time that the electronic device 12 still needs to be charged being greater than 8 hours represents that the charging time of the electronic device is too long. Then the computer system 10 will provide a user with an option of speeding charging under this circumstance. When the user chooses to speed charging, the firmware 16 will start to adjust the performance of the computer system 10 for distributing more current to flow into the electronic device 12 as described in Step 310. And when the user chooses not to speed charging, the firmware 16 will not execute adjusting the performance of the computer system 10, that is to say, the electronic device 12 will be charged by the initial current when coupled to the computer system 10. Step 308 and step 310 can be omitted.

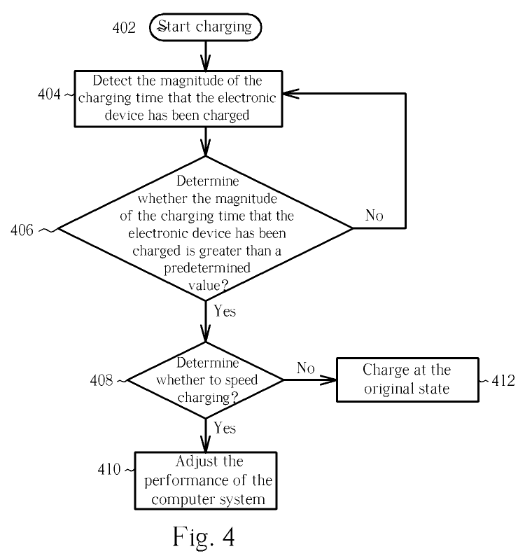

Please refer to FIG. 4. FIG. 4 is a flowchart of a method for adjusting the charging current flowing into the electronic device 12 according to the magnitude of the charging time that the electronic device 12 has been charged. The method comprises the following steps.

Step 402: Start charging the electronic device 12;

Step 404: The detecting unit 14 detects the charging time that the electronic device 12 has been charged;

Step 406: The detecting unit 14 determines whether the magnitude of the charging time that the electronic device 12 has been charged is greater than a predetermined value. If so, go to Step 408. If not, go to Step 404;

Step 408: The user determines whether to speed charging. If so, go to Step 410. If not, go to Step 412;

Step 410: The firmware 16 adjusts the performance of the computer system 10;

Step 412: Charge the electronic device at the original state.

Steps mentioned in both FIG. 2 and FIG. 4 represent similar steps. Step 406 in FIG. 4 is a step for determining whether the charging time of the electronic device 12 is too long. For example, if the predetermined value is 8 hours, the charging time that the electronic device 12 has been charged greater than 8 hours represents that the charging time of the electronic device is too long. Then the computer system 10 will provide a user with an option of speeding charging under this circumstance. When the user chooses to speed charging, the firmware 16 will start to adjust the performance of the computer system 10 for distributing more current to flow into the electronic device 12 as described in Step 410. And when the user chooses not to speed charging, the firmware 16 will not execute adjusting the performance of the computer system 10. That is to say, the electronic device 12 will be charged by the initial current when coupled to the computer system 10. Step 408 and step 410 can be omitted.

The present invention utilizes the embodiments mentioned above to adjust the performance of the computer system based on the charging state of the electronic device for increasing the charging current flowing into the electronic device. When a current for charging an electronic device is too small, the electronic device has been charged for a long time, or the electronic device still needs to be charged for a long time, and when the user wants to speed charging, the present invention increases the current for charging the electronic device through decreasing the power consumption of the other components other than the electronic device inside the computer system. This will avoid the problem of the electronic device not being able to be completely charged within a limited time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting a charging time of an electronic device coupled to a computer system comprising:
adjusting a charging current from the computer system to the electronic device according to the charging status of the electronic device.

2. The method of claim 1, wherein the charging status comprises a magnitude of a charging current.

3. The method of claim 2 further comprising detecting whether the magnitude of the charging current from the computer system to the electronic device is smaller than a predetermined value.

4. The method of claim 3 further comprising providing a user with an option of speeding charging when the magnitude of the charging current is smaller than the predetermined value, and raising the magnitude of the charging current from the computer system to the electronic device when the user chooses to speed charging.

5. The method of claim 3 further comprising raising the magnitude of the charging current from the computer system to the electronic device when the magnitude of the charging current from the computer system to the electronic device is smaller than the predetermined value.

6. The method of claim 1, wherein the charging status comprises a magnitude of a charging time.

7. The method of claim 6 further comprising detecting whether the magnitude of the charging time that the electronic device still needs to be charged is greater than a predetermined value.

8. The method of claim 7 further comprising providing a user with an option of speeding charging when the magnitude of the charging time that the electronic device still needs to be charged is greater than the predetermined value, and raising the magnitude of the charging current from the computer system to the electronic device when the user chooses to speed charging.

9. The method of claim 7 further comprising raising the magnitude of the charging current from the computer system to the electronic device when the magnitude of the charging time that the electronic device still needs to be charged is greater than the predetermined value.

10. The method of claim 6 further comprising detecting whether the magnitude of the charging time that the electronic device has been charged is greater than a predetermined value.

11. The method of claim 10 further comprising providing a user with an option of speeding charging when the magnitude of the charging time that the electronic device has been charged is greater than the predetermined value, and raising the magnitude of the charging current from the computer system to the electronic device when the user chooses to speed charging.

12. The method of claim 10 further comprising raising the magnitude of the charging current from the computer system to the electronic device when the magnitude of the charging time that the electronic device has been charged is greater than the predetermined value.

13. The method of claim 1 further comprising coupling the computer system to a power supply.

14. The method of claim 13, wherein the electronic device is a battery.

15. The method of claim 1, wherein the electronic device is a USB device.

16. The method of claim 1, wherein adjusting the charging current flowing into the electronic device comprises adjusting the performance of the computer system.

17. The method of claim 16, wherein adjusting the performance of the computer system comprises starting the chipset-throttling mode of the computer system.

18. The method of claim 17, wherein starting the chipset-throttling mode of the computer system comprises starting a CPU of the computer system into performance state.

19. The method of claim 16, wherein adjusting the performance of the computer system comprises starting the power-saving mode of the computer system.
